(19) United States
(12) Patent Application Publication
(10) Pub. No.: US 2012/0234055 A1
(43) Pub. Date: Sep. 20, 2012

(54) TABLET COMPUTER LOCK MECHANISM

(75) Inventors: James L. Bland, III, Leesburg, VA (US); Jeffrey M. Kalman, Cleveland Heights, OH (US); James E. Szpak, Cleveland Heights, OH (US); Jason G. Tilk, Cleveland Heights, OH (US); David J. Boll, Avon, OH (US)

(73) Assignee: CODI, INC., Harrisburg, PA (US)

(21) Appl. No.: 13/422,609

(22) Filed: Mar. 16, 2012

Related U.S. Application Data
(60) Provisional application No. 61/453,672, filed on Mar. 17, 2011.

(51) Int. Cl. E05B 73/00

(52) U.S. Cl. 70/15; 70/14

(57) ABSTRACT

A tablet computer lock mechanism includes at least two arms configured to engage an associated tablet computer, a locking mechanism connected with each arm, and a cable lock mechanism associated with the locking mechanism. The locking mechanism is configured to draw at least one of the at least two arms into engagement with an associated tablet computer. The cable lock mechanism is configured to capture a cable to preclude removal of the cable from the cable lock mechanism

This application claims priority to Application Ser. No. 61/453,672, filed Mar. 17, 2011.

### BACKGROUND

Security devices for portable electronic devices such as laptop computers are known. Such security devices include a lock mechanism and a cable. The cable and lock mechanism attaches with the case or housing of the laptop computer and the cable can be looped around an office desk or similar large piece of furniture to secure the laptop computer to the same.

Such security devices, however, are not suitable for a typical tablet computer. Many known tablet computers do not include an appropriate interface to allow for the attachment of a lock mechanism suitable for use with laptop computers.

Tablet computer stands are also known. These stands typically allow a tablet computer to be propped upright for easier viewing on a desktop. Nevertheless, these known tablet computer stands do not include a lock mechanism to deter theft.

### SUMMARY

An example of a table computer lock mechanism that can overcome at least one of the aforementioned shortcomings includes at least two arms configured to grip an associated tablet computer and a lock mechanism operably connected with each arm. The at least two arms includes at least one movable arm movable between an extended position and a retracted position. The lock mechanism includes a lock cable receptacle configured to receive an end of a lock cable. The locking mechanism is operable in a locked mode and an unlocked mode. When in the locked mode, the locking mechanism is configured to preclude removal of the end of the lock cable from the lock cable receptacle and the at least one movable arm is in the retracted position. When the locking mechanism is in the locked mode, each arm is positioned to grip the associated tablet computer whereby removal of the associated tablet computer from the at least two arms requires damage to the tablet computer lock mechanism and/or the associated tablet computer. When in the unlocked mode, the locking mechanism is configured to allow removal of the end of the lock cable from the lock cable receptacle and the at least one movable arm is in the extended position. As such, removal of the associated tablet computer from the at least two arms does not result in damage to the tablet computer lock mechanism and/or the associated tablet computer when the locking mechanism is in the unlocked mode.

Another example of a tablet computer lock mechanism includes at least two arms configured to engage an associated tablet computer and a locking mechanism connected with each arm. The locking mechanism includes a movable component, a fixed component operably connected with the movable component, and a lock operably connected with at least one of the movable component and the fixed component. The at least two arms includes at least one movable arm operably connected with the movable component and movable between an extended position and a retracted position. The movable component is movable with respect to the fixed component between a locked position and an unlocked position. Movement of the movable component with respect to the fixed component results in movement of the at least one movable arm with respect to the fixed component. The lock is operable between a locked state and an unlocked state. The lock is movable from the unlocked state to the locked state when the movable component is in the locked position. The lock precludes movement of the movable arm with respect to the fixed component when in the locked state.

Another example of a tablet computer lock mechanism includes at least two arms configured to engage an associated tablet computer, a locking mechanism connected with each arm, and a cable lock mechanism associated with the locking mechanism. The locking mechanism is configured to draw at least one of the at least two arms into engagement with an associated tablet computer. The cable lock mechanism is configured to capture a cable to preclude removal of the cable from the cable lock mechanism.

### BRIEF DESCRIPTION OF THE DRAWINGS

FIG. 1 is a perspective view of a tablet computer lock mechanism engaged with a tablet computer.

FIG. 2 is an exploded view of the tablet computer lock mechanism depicted in FIG. 1.

FIG. 3 is another exploded view of the tablet computer lock mechanism at an angle opposite to that shown in FIG. 2.

FIG. 4 is a perspective view of another embodiment of a tablet computer lock mechanism engaged with a tablet computer.

FIG. 5 is an exploded view of the tablet computer lock mechanism depicted in FIG. 4.

FIG. 6 is another exploded view of the tablet computer lock mechanism depicted in FIG. 4 from a view opposite to that shown in FIG. 5.

### DETAILED DESCRIPTION

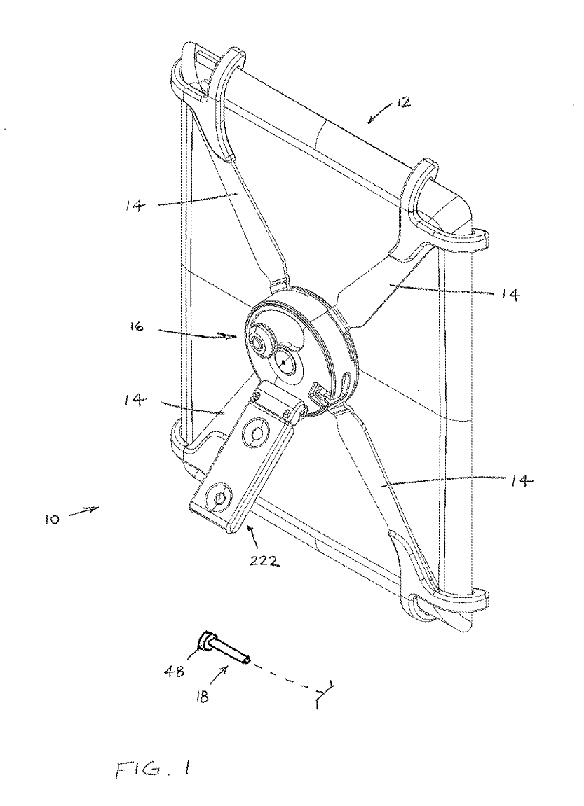

FIG. 1 depicts a tablet computer lock mechanism 10 engaged with a tablet computer 12. The tablet computer lock mechanism 10 generally includes a plurality of arms 14 each connected with a locking mechanism 16. The tablet computer lock mechanism 10 can be useful to prop up or stand the tablet computer 12 on an associated support surface, such as a desktop. Moreover, the tablet computer lock mechanism 10 can cooperate with a lock cable 18 (only a portion of which is depicted in FIG. 1) to lock a tablet computer 12 to another structure, such as a desk or other structure that is difficult to move. As such, the tablet computer lock mechanism 10 can be used to secure the tablet computer 12 and deter theft.

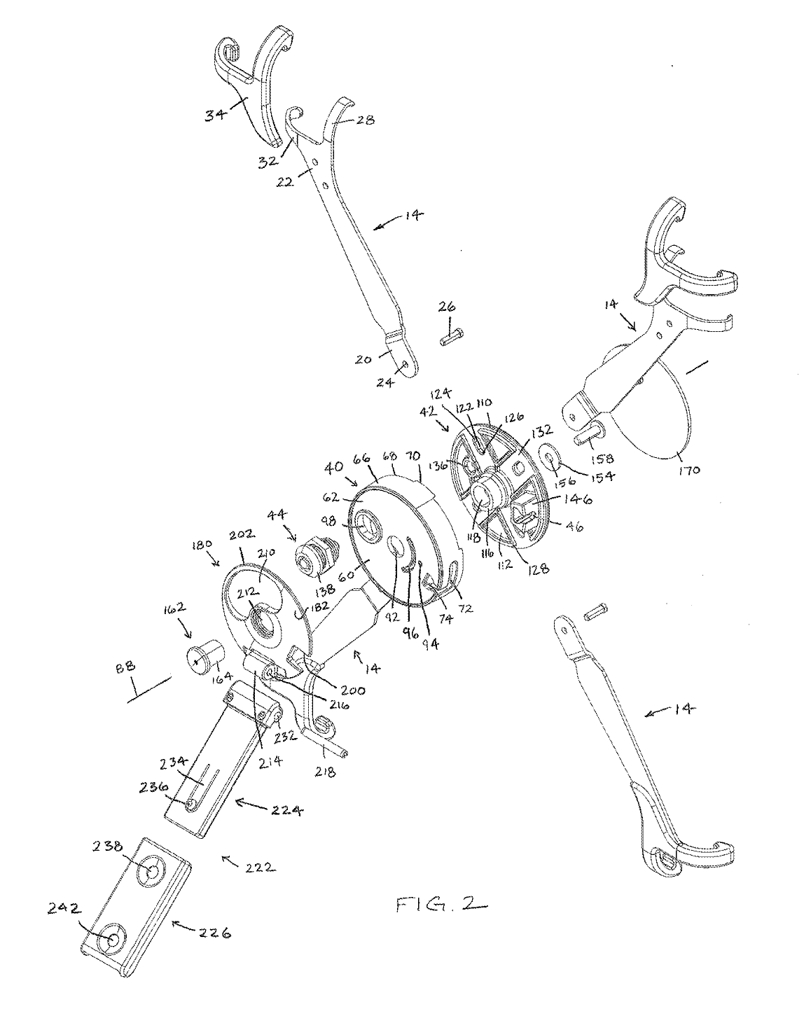

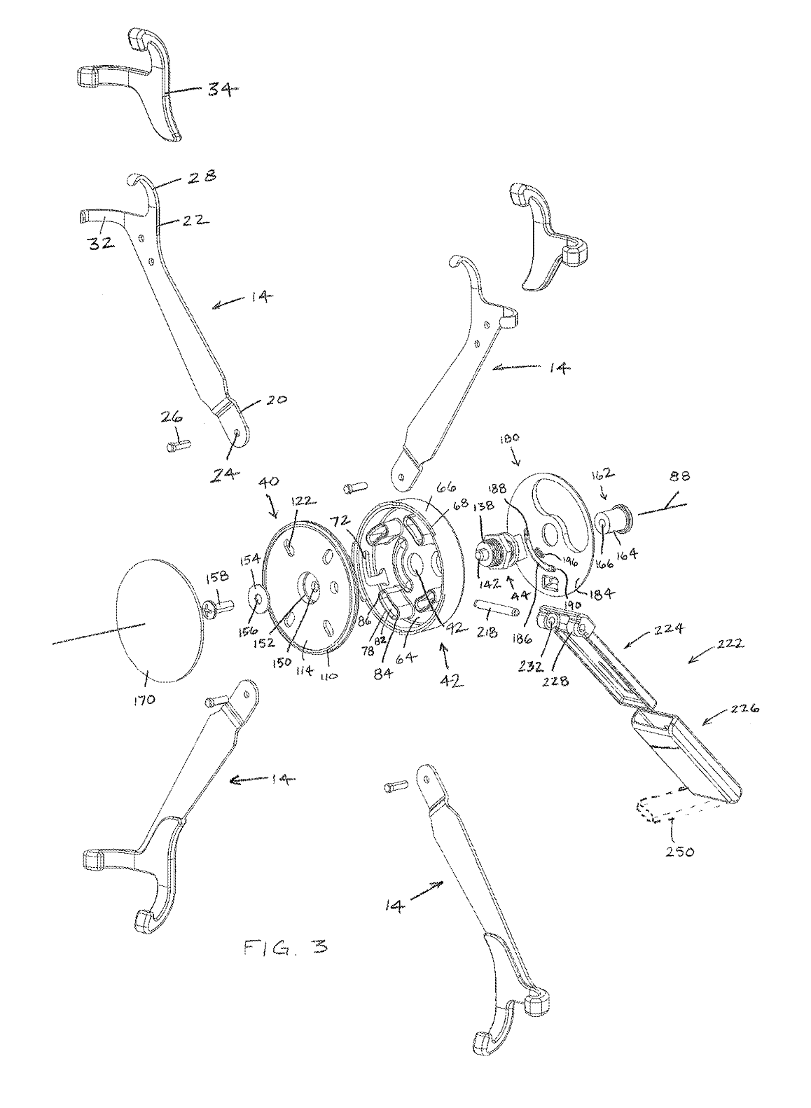

With reference to FIGS. 2 and 3, each arm 14 is similarly configured. With reference back to FIG. 1, the arms 14 that engage opposite corners of the tablet computer 12 are identical in configuration, while the arms that engage adjacent corners of the tablet computer are mirror images of one another. For the sake of brevity, only one of the arms will be described in detail with the understanding that the remaining arms are either identical or mirror images thereof.

With reference back to FIG. 2, each arm 14 includes a proximal end portion 20 and a distal end portion 22. A pin opening 24, which receives a pin 26, is formed in the proximal end portion 20. In the illustrated embodiment four pins 26 are provided; one for each arm 14. A first finger 28 extends from the distal end portion 22 of the arm 14. A second finger 32 also extends from the distal end portion 22. The arm 14 can be made from a rigid material, such as metal. A resilient grip 34 overlays the distal end portion 22, the first finger 28, and the second finger 32 to reduce the likelihood of damage to the casing of the tablet computer 12. The first finger 28 is oriented substantially perpendicular to the second finger 32 so that the first finger 28 engages a first (longer) side of the tablet computer 12 and the second finger 32 engages an adjacent (shorter) side of the tablet computer, which is perpendicular to the first side. The fingers 28 and 32 wrap around from a rear surface of the tablet computer 12 to a forward surface thereof.

With reference back to FIG. 1, the arms 14 can take the form of an x-shaped configuration on the rear of the tablet computer 12. Each of the respective fingers 28, 32 of each arm 14 can grip near a respective corner of the tablet computer 12. In the illustrated embodiment, each of the arms 14 is movable between an extended position and a retracted position. The arms 14 are shown in the retracted position in FIG. 1. In the retracted position, the fingers 28, 32 of each arm 14 are positioned to grip the tablet computer 12 whereby removal of the tablet computer from the arms 14 requires damage to the tablet computer lock mechanism 10 and/or damage to the tablet computer 12. Movement of the arms from the retracted position into the extended position will be described in more detail below.

With reference to FIG. 2, the locking mechanism 16 includes a movable component 40, a fixed component 42 operably connected with the movable component, and a lock 44 operably connected with at least one of the movable component and the fixed component. The locking mechanism 16 is also operably connected with each arm 14 and includes a lock cable receptacle 46, which is a component of a cable lock mechanism, configured to receive an end 48 (FIG. 1) of the lock cable 18 (FIG. 1). The locking mechanism 16 is operable in a locked mode, which is shown in FIG. 1, and an unlocked mode. When in the locked mode, the locking mechanism 16 is configured to preclude removal of the end 48 of the lock cable 18 from the lock cable receptacle 46 and at least one of the arms 14 is in the retracted position. When the locking mechanism 16 is in the locked mode, each arm 14 is positioned to grip the tablet computer 12 whereby removal of the tablet computer from the arms 14 requires damage to the tablet computer lock mechanism 10 and/or damage to the tablet computer 12. When in the unlocked mode, the locking mechanism 16 is configured to allow removal of the end 48 of the lock cable 18 from the lock cable receptacle 46 and at least one of the arms 14 is in the extended position. When in the unlocked mode, removal of the tablet computer 12 from the arms 14 does not result in damage to the tablet computer lock mechanism 10 and/or the associated tablet computer 12. The locking mechanism 16 is also configured to draw at least one of the arms 14 into engagement with the tablet computer 12. The cable lock mechanism, which also includes the cable receptacle 46, is configured to capture the cable 18 to preclude removal of the cable from the cable lock mechanism.

With reference back to FIG. 2, the movable component 40 includes a pedestal 60 having an upper surface 62 and a lower surface 64 (FIG. 3). The upper surface 62 and the lower surface 64 are referred to as such with respect to the orientation of the tablet computer lock mechanism 10 as depicted in the drawings. In the illustrated embodiment, the pedestal 60 is circular in configuration. The movable component 40 further includes a shroud 66, which is generally cylindrical in configuration, depending downwardly from the pedestal 60. The shroud 66 includes a plurality of notches 68 at a lower edge 70. Each notch 68 receives a respective arm 14 when the movable component 40 is connected with the fixed component 42.

The movable component 40 further includes an L-shaped cable slot 72. The L-shaped cable slot 72 is formed in the shroud 66 and extends into the pedestal 60. The L-shaped cable slot 72 has a cable slot outlet 74 extending into the pedestal 60. The movable component 40 is movable with respect to the fixed component 42 between a locked position, which is shown in FIG. 1, and an unlocked position. In the embodiment depicted in FIGS. 1-3, the movable component 40 rotates with respect to the fixed component 42. The cable slot outlet 74 aligns with the cable receptacle 46 when the movable component 40 is in the unlocked position. With the movable component 40 in the unlocked position, the end 48 (FIG. 1) of the cable 18 is able to be removed from the receptacle 46.

With reference to FIG. 3, the movable component 40 further includes a plurality of cam members 78 that depend downwardly from the lower surface 64 of the pedestal 60. Each cam member 78 (four cam members are shown in FIG. 3) defines a cavity 82 configured to receive a respective pin 26. Each cam member 78 includes a distal curved end wall 84 and a proximal curved end wall 86 with respect to a rotational axis 88 of the movable component 40. When the movable component 40 is in the unlocked position, the respective pin 26 received in the cavity 82 is disposed adjacent the distal end wall 84 of the cam member 78. When the movable component 40 is in the locked position, the respective pin 26 is disposed adjacent the proximal end wall 86. Since the distal end wall 84 is disposed further from the rotational axis 88 as compared to the proximal end wall 86, the arm 14 is in the extended position when the pin 26 is disposed adjacent the distal end wall 84 and the arm is in the retracted position when the pin is disposed adjacent the proximal end wall 86. As such, rotation of the movable component 40 about the rotational axis 88 moves the arms 14 between the extended position and the retracted position. Per the orientation shown in FIG. 2, movement of the movable component 40 in the clockwise direction results in translational movement of the arm 14 from the extended position toward the retracted position.

With reference back to FIG. 2, the movable component 40 further includes a central opening 92 that is centered with respect to the rotational axis 88. A bump 94 extends upwardly from the upper surface 62 of the pedestal 60 and is offset from the central opening 92. A curved (semi-circular) groove 96, which generally follows a constant radius emanating from the rotational axis 88, is disposed between the bump 94 and the central opening 92. The curved groove 96 extends inwardly from the upper surface 62 of the pedestal 60. The movable component 40 further includes a lock opening 98 that receives the lock 44. The lock 44 connects with the movable component 40 such that rotation of the movable component 40 results in movement of the lock 44 about the rotational axis 88.

The fixed component 42 includes a circular base 110. The circular base includes an upper surface 112 (FIG. 2) and a lower surface 114 (FIG. 3). The fixed component 42 further includes a central boss 116, which is cylindrical in the illustrated embodiment. The central boss 116 defines a central bore 118, which is circular and centered along the rotational axis 88.

The fixed component 42 further includes elongate slots 122, which are elongated in a radial direction. The width (measured generally perpendicular to the radial direction) of each of the slots 122 is slightly larger than the diameter of the pins 26. The slots 122 receive the pins 26. Each slot 122 includes an outer end 124 adjacent which the respective pin 26 resides when the respective arm 14 is in the extended position, and an inner end 126, adjacent which the respective pin 26 resides when the arm is in the retracted position. The fixed component 42 further includes pie-shaped projections 128, which define arm-receiving channels 132. The distal end portion 20 of each arm 14 is received in each respective arm-receiving channel 132. Rotation of the movable component 40 with respect to the fixed component 42 results in translational movement of the distal portion 20 of each arm 14 in a respective arm-receiving channel 132.

The fixed component 42 further includes a lock member opening 136. The lock 44 includes a lock housing 138 and a movable member 142 (FIG. 3). The lock 44 is operable between a locked state and an unlocked state. The lock 44 is movable from the unlocked state to the locked state when the movable component 40 is in the locked position. The lock 44 precludes movement of the movable component 40 with respect to the fixed component 42 when in the locked state. The movable member 142 of the lock 44 engages the fixed component 42 when the lock is in the locked state to preclude movement of the movable component 40 with respect to the fixed component 42 when the lock 44 is in the locked state. The movable member 142 of the lock 44 is aligned with the opening 136 in the fixed component 42 when the movable component is in the locked position, such as that shown in FIG. 1. The movable member 142 of the lock 44 is offset from the opening 136 in the fixed component 42 when the movable component 40 is in the unlocked position. As such, the lock 44 is unable to occupy the locked state when the movable component 40 is in the unlocked position. The lock 44 can be similar to known locks and be operated by a key carried by the owner of the tablet computer lock mechanism 10. Movement of the key within the lock 44 moves the movable member 142 to move the lock between the locked state, where the movable member 142 is received in the opening 136, and the unlocked state where the movable member 142 is not received within the lock member opening 136.

The fixed component 42 also includes a cable receptacle housing 146 defining the cable receptacle 46. The cable receptacle housing 146 extends upwardly from the upper surface 112. As mentioned above, the movable component 40 includes the cable slot 72 having the cable slot outlet 74. The cable slot outlet 74 aligns with the cable receptacle 46 when the movable component 40 is in the unlocked position. As such, when the movable component 40 is in the unlocked position, the end 48 (FIG. 1) of the lock cable 18 can be removed from the cable receptacle 46 through the cable slot outlet 74. When the movable component 40 is in the locked position, which is shown in FIG. 1, the cable slot outlet 74 is not aligned with the cable receptacle 46. As such, when the movable component 40 is in the locked position removal of the end 48 (FIG. 1) of the cable 18 from the cable receptacle 46 is precluded.

With reference to FIG. 3, the fixed component 42 further includes a fastener opening 150 centered with respect to the rotational axis 88. The fastener opening 150 is disposed within a counter bore 152 formed in the lower surface 114 of the fixed component 42. The counter bore 152 is cylindrical in configuration and centered with respect to the rotational axis 88. The counter bore 152 receives a washer 154 having a central opening 156 that receives a fastener 158. The fastener 158 connects with a hub 162 having a cylindrical bearing surface 164 and a central opening 166 that receives the fastener 158. With reference back to FIG. 2, the hub 162 is received the central opening 92 of the movable component 40 and the central bore 118 of the central boss 116. The fastener 158 is received through the opening 156 in the washer 154 and the central opening 150 in the fixed component 42 and finally received in the opening 166 formed in the hub 162. The fastener 158 in combination with the hub 162 connects the movable component 40 to the fixed component 42. A cover plate 170 can be provided to cover the fastener 158 and attach along the lower surface 114 of the fixed component 42. The cover plate 170 can protect the housing of the tablet computer 12 from the fastener 158.

With reference to FIG. 2, the tablet computer lock mechanism 10 can further include a rotating stand hub 180. The rotating stand hub 180 connects with the locking mechanism 16. The rotating stand hub 180 is movable with respect to the movable component 40 and the fixed component 42 of the locking mechanism 16. In the illustrated embodiment, the rotating stand hub 180 is generally circular and rotates about the rotational axis 88. The rotating stand hub 180 includes an upper surface 182 (FIG. 2) and a lower surface 184 (FIG. 3).

With reference to FIG. 3, a curved (semi-circular) recess 186, which generally follows a radius emanating from the rotational axis 88, is formed in the lower surface 184 of the rotating stand hub 180. The curved recess 186 includes a first end 188 and a second end 190. With reference to FIG. 2, the bump 94 formed on the upper surface 62 of the pedestal 60 of the movable component 40 resides within the curved recess 186. Each of the ends 188, 190 are deeper than the remainder of the recess 186. As such, when the rotating stand hub 180 rotates with respect to the movable component 40, a tactile feature is provided to the operator when the bump 94 moves adjacent the first end 188 or the second end 190. The rotating stand hub 180 further includes a protrusion 196 that resides in the curved recess 96 formed in the upper surface 62 of the movable member 40.

The rotating stand hub 180 further includes a notch 200 extending inwardly from a peripheral edge 202 of the rotating stand hub 180. The notch 200 aligns with the cable slot outlet 74 when the rotating stand hub 180 is appropriately positioned. Alignment of the notch 200 with the cable slot outlet 74 allows for removal of the end 48 (FIG. 1) of the lock cable 18.

The rotating stand hub 180 further includes a kidney shaped opening 210 offset from the rotational axis 88. The lock 44 is received in the kidney shaped opening 210. The configuration of the kidney shaped opening 210 allows for rotational movement of the rotating stand hub 180 with respect to the movable component 40.

The rotating stand hub 180 further includes a central opening 212 that is centered with respect to the rotational axis 88. The central opening 212 receives the hub 162, which connects the rotating stand hub 180 with the movable component 40 and the fixed component 42 of the locking mechanism 16.

The rotating stand hub 180 further includes an axle attachment 214 having an opening 216 for receiving an axle 218 to connect an extendable leg 222 with the rotating stand hub 180.

The tablet computer lock mechanism 10 further includes the extendable leg 222 connected with the rotating stand hub 180. The extendable leg 222 includes a first section 224 and a second section 226, which receives the first section. With reference to FIG. 3, the first section 224 includes bearings 228 having openings 232 that receive the axle 218 for connecting the extendable leg 222 to the rotating stand hub 180. The extendable leg 222 can rotate about the axle 218 with respect to the rotating stand hub 180. The first section 224 further includes an integral leaf spring 234 having a distal protrusion 236. The relief spring 234 is resilient. The second section 226, which is hollow to receive the first section 224, includes a proximal hole 238 and a distal hole 242. The distal protrusion 236 on the relief spring 234 is selectively receivable in each of the proximal hole 238 and the distal hole 242. To place the extendable leg 222 in the extended position, the distal protrusion 236 is received in the proximal hole 238. To place the extendable leg 222 in the retracted position, the proximal hole 236 receives in the distal protrusion 242.

The rotating stand hub 180 is movable between a portrait position, which is shown in FIG. 1, and a landscape position, where the rotating stand hub 180 is rotated 90 degrees with respect to the position shown in FIG. 1. When in the portrait position, the extendable leg 22 is positioned with respect to the plurality of arms 14 to support the tablet computer 12 in a portrait orientation, such as that shown in FIG. 1. When in the landscape position, the extendable leg 222 is positioned with respect to the plurality of arms 14 to support the tablet computer in a landscape orientation. The extendable leg 222 can lock in an extended position, where the distal protrusion 236 is received in the proximal opening of the second section 226 and a retracted position where the distal protrusion 236 is received in the distal opening 242 of the second section 226. This allows the tablet computer 12 to be oriented in a portrait “up” orientation and a portrait “down” orientation. In the portrait “up” orientation the tablet computer 12 is nearer to vertical as compared to the portrait “down” orientation. Likewise, the tablet computer can be supported in a landscape “up” orientation and a landscape “down” orientation.

With reference to FIG. 3, the second section 226 of the extendable leg 222 can include a pivoting stand section 250 that pivots with respect to the remainder of the second section 226. The pivoting stand section 250 is movable between an extended position (shown in phantom in FIG. 3) and a retracted position. When in the extended position, the distal end of the pivoting stand section 250 can engage a rear surface of the table computer 12.

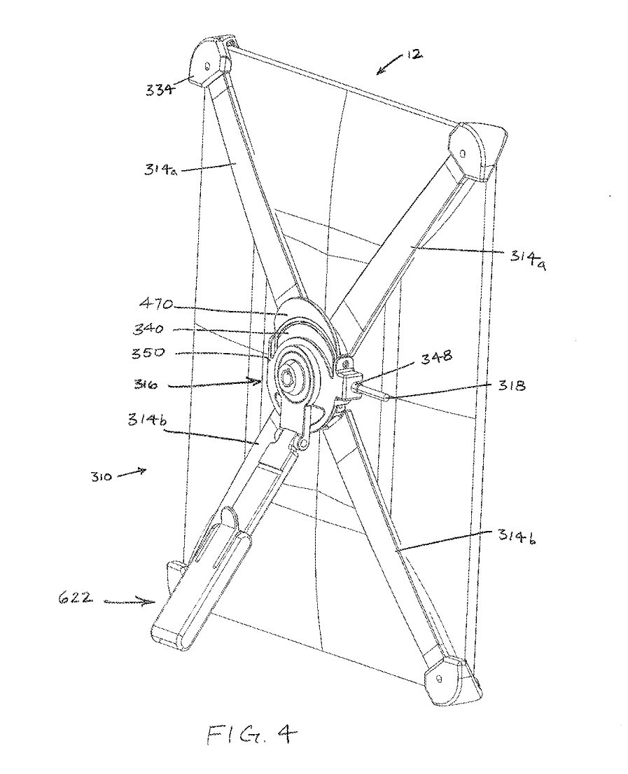

FIG. 4 depicts a tablet computer lock mechanism 310 engaged with the tablet computer 12. The tablet computer lock mechanism 310 generally includes a plurality of arms 314a, 314b each connected with a locking mechanism 316. The tablet computer lock mechanism 310 can be useful to prop up or stand the tablet computer 12 on an associated support surface, such as a desktop. Moreover, the tablet computer lock mechanism 310 can cooperate with a lock cable 318 to lock the tablet computer 12 to another structure, such as a desk or other structure that is difficult to move. As such, the tablet computer lock mechanism 310 can be used to secure the tablet computer 12 and deter theft.

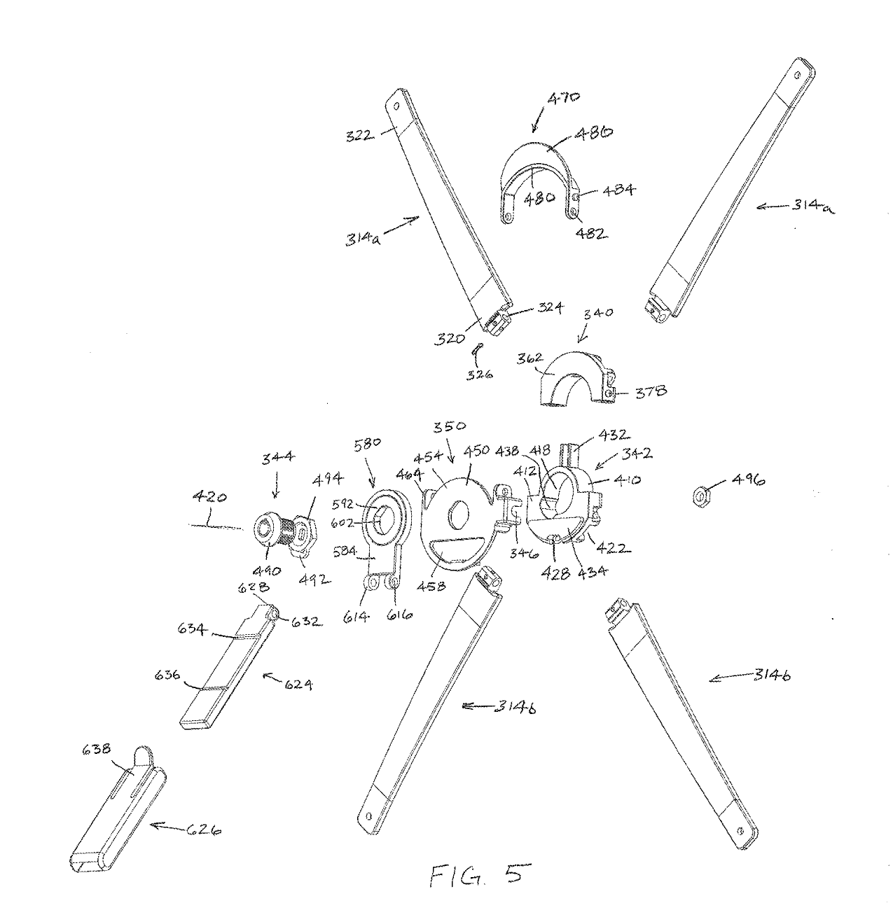

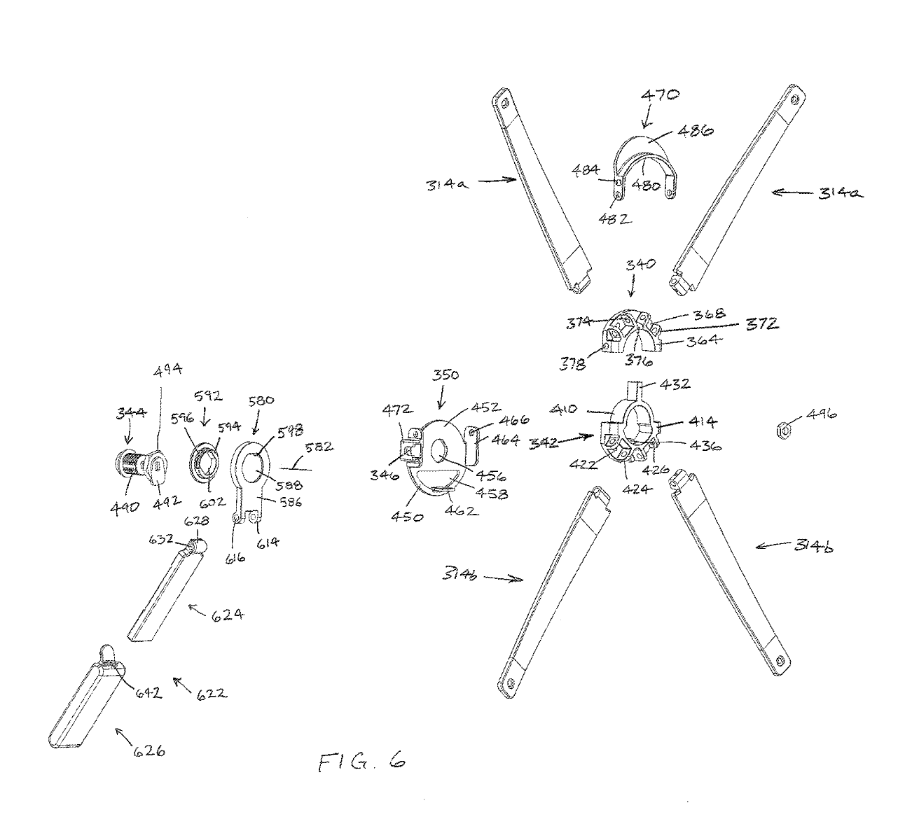

With reference to FIGS. 5 and 6, each arm 314a, 314b is similarly configured. For the sake of brevity, only one of the arms 314a, 314b will be described in detail with the understanding that the remaining arms are identical. Each arm 314a, 314b includes a proximal end portion 320 and a distal end portion 322. A fastener opening 324, which receives a fastener 326 (only one fastener is shown in FIG. 5), is formed in the proximal end portion 320. A resilient grip 334 (only visible in FIG. 4) attaches to the distal end portion 322. The resilient grip 334 wraps around from a rear surface of the tablet computer 12 to a forward surface thereof.

With reference back to FIG. 4, the arms 314a, 314b can take the form of an x-shaped configuration on the rear of the tablet computer 312. Each of the respective resilient grips 334 of each arm 314a, 314b can grip a respective corner of the tablet computer 12. In the illustrated embodiment and per the orientation shown in FIGS. 4-6, the upper arms 314a are movable between an extended position and a retracted position. The upper arms 314a are shown in the retracted position in FIG. 1. In the retracted position, the resilient grips 334 of each arm 314a, 314b are positioned to grip the tablet computer 12 whereby removal of the tablet computer from the arms 314a, 314b requires damage to the tablet computer lock mechanism 310 and/or damage to the tablet computer 12. Movement of the upper arms 314a from the retracted position into the extended position will be described in more detail below.

With reference to FIG. 5, the locking mechanism 316 includes a movable component 340, a fixed component 342 operably connected with the movable component, and a lock 344 operably connected with at least one of the movable component and the fixed component. The locking mechanism 316 is also operably connected with each arm 314a, 314b. The locking mechanism 316 also includes a lock cable receptacle 346, which is a component of a cable lock mechanism, configured to receive an end 348 (FIG. 4) of the lock cable 318. The cable receptacle 346 in the embodiment depicted in FIGS. 4-6 is provided on a latch link 350, which will be described in more detail below.

The locking mechanism 316 is operable in a locked mode, which is shown in FIG. 4, and an unlocked mode. When in the locked mode, the locking mechanism 316 is configured to preclude removal of the end 348 of the lock cable 318 from the lock cable receptacle 346 and at least one of the arms 314 (the two upper arms 314a in FIG. 4) is in the retracted position. When the locking mechanism 316 is in the locked mode, each arm 314a, 314b is positioned to grip the tablet computer 12 whereby removal of the tablet computer from the arms 314a, 314b requires damage to the tablet computer lock mechanism 310 and/or damage to the tablet computer 12. When in the unlocked mode, the locking mechanism 316 is configured to allow removal of the end 348 of the lock cable 318 from the lock cable receptacle 346 and at least one of the arms 314 (each upper arm in FIG. 4) is in the extended position. When in the unlocked mode, removal of the tablet computer 12 from the arms 314a, 314b does not result in damage to the tablet computer lock mechanism 310 and/or the associated tablet computer 12. The locking mechanism 316 is also configured to draw at least one of the arms (each upper arm 314a in FIG. 4) into engagement with the tablet computer 12. The cable lock mechanism, which also includes the cable receptacle 346, is configured to capture the cable 318 to preclude removal of the cable from the cable lock mechanism.

With reference back to FIG. 4, the movable component 340 is a generally U-shaped body having an upper surface 362, which faces away from the tablet computer 12, and a lower surface 364 (FIG. 5), which faces toward the tablet computer. The movable member 340 further includes two upper arm notches 368 at the lower surface 362. Each notch 368 receives a respective upper arm 314a. Each upper arm notch 368 is defined between respective bracket walls 372 each having a respective fastener opening 374. The fastener openings 374 receive a fastener 326 to attach a respective upper leg 314a in each notch 368. A central notch 376 is formed between the respective upper-arm notches 368. Axle extensions 378 are formed on opposite sides of the movable component.

The fixed component 342 includes a generally cylindrical base section 410. The cylindrical base section 410 includes an upper side 412, which faces away from the tablet computer 12, and a lower side 414 (FIG. 6), which faces the tablet computer 12. The fixed component 342 further includes a central bore 418, which is circular and centered along a rotational axis 420 of the lock 344, which will be described in more detail below.

The fixed component 342 further includes two lower arm notches 422 at the lower side 414. Each notch 422 receives a respective lower arm 314b. Each lower arm notch 422 is defined between respective bracket walls 424 each having a respective fastener opening 426. The fastener openings 426 receive the fastener 326 to attach a respective lower leg 314b in each notch 422. A central notch 428 is formed between the respective lower arm notches 422. A central extension 432 extends upwardly from the generally cylindrical base section 410 from the 12 o'clock position of the generally cylindrical base section. The central extension 432 fits within the central notch 376 of the movable component 340. The fixed component 342 further includes a raised section 434 on the upper side 412. The raised section 434 cooperates with the latch link 350 in a manner that will be described in more detail to follow. The fixed component 342 also includes a shoulder 436 offset inwardly from the lower side 432. The shoulder 436 terminates at a notch 438 that opens to the central bore 418.

The latch link 350 includes a generally cylindrical base section 450 having a lower surface 452 that contacts the upper surface 362 of the movable component 340 and the upper side 412 of the fixed component 342. The latch link 350 also includes an upper surface 454 opposite the lower surface 452. The latch link 350 further includes a lock-receiving opening 456 through the generally cylindrical base section 450. The lock 344 is received through the lock-receiving opening 456. The latch link 350 also includes an index opening 458, which receives the raised section 434 of the fixed component 342 to properly align the latch link 350 with the fixed component 342.

The latch link 350 further includes a tab 462, which extends inwardly toward the fixed component 342 from the lower surface 452. The tab 462 is received in the central notch 428 formed between the respective lower arm notches 422 in the fixed component 432. Inwardly extending ears 464 extend from opposite sides of the generally cylindrical base section 450 toward the fixed component 432. Each inwardly extending ear 464 includes a respective hole 466, which cooperates with a latch lever 470, which will be described in more detail below. A receptacle housing 472, which defines the cable receptacle 346, extends from one of the ears 464.

The latch lever 470 includes a generally U-shaped body 480. Axle openings 482, which each receive a respective axle extension 378 on the movable component 430, are provided to connect the latch lever 470 with the movable component. The latch lever 470 further includes bumps 484 formed above the axle openings 482. The bumps 484 are selectively received in the openings 466 formed in the ears 464 on the latch link 450. The latch lever 470 further includes an extension 486, which allows an operator to grasp the latch lever 470 to rotate the latch lever about the axle extensions 378.

The lock 344 includes a lock housing 490 and a movable tab 492. A larger nut 494 connects with the lock 344 to connect the latch link, 350, the fixed component 342, the movable component 340 and the latch lever 470 together. A smaller nut 446 attaches the movable tab 492 with the lock housing 490. The lock 344 is operable between a locked state and an unlocked state. The lock 344 precludes movement of the movable component 340 with respect to the fixed component 342 when in the locked state. The movable tab 492 of the lock 344 engages the fixed component 342 when the lock is in the locked state to preclude movement of the movable component 340 with respect to the fixed component 342 when the lock 334 is in the locked state. The movable tab 492 of the lock 344 engages the shoulder 436 in the fixed component 342 when the lock 344 is in the locked state. The movable tab 492 of the lock 44 is offset from the shoulder 436 in the fixed component 342 and resides in the notch 438 is in the unlocked state. The lock 344 can be similar to known locks and be operated by a key carried by the owner of the tablet computer lock mechanism 10. Movement of the key within the lock 344 moves the movable tab 492 to move the lock between the locked state and the unlocked state.

When the movable tab 492 engages the shoulder 436 of the fixed component 342 axial movement (in a direction away from the tablet computer 12) of the latch link 450 is precluded. Since the latch lever 470 contacts the lower surface 452 of the latch link 350, rotational movement of the latch lever 470 is precluded when the lock 344 is in the locked state. Since the latch lever 470 contacts the movable component 430, movement of the movable component 430 with respect to the fixed component 432 is precluded with the lock 344 in the locked state. With the lock 344 in the unlocked state, the latch lever 470 can rotate about the axle extensions 378 because the latch link 350 can move axially away from the tablet computer 12. With the latch lever 470 rotated away from the tablet computer the movable component 340 is movable away (upward per the orientation shown in the figures) from the fixed component 342. Rotation of the latch lever 470 back toward the tablet computer 12 and downward (per the orientation shown in the figures) movement of the latch lever 470 results in the movable component 340 moving toward the fixed component 432. This results in the upper arms 314a moving toward the retracted position to engage the tablet computer 12. With the latch lever 470 fully rotated toward the tablet computer 12 the bumps 484 on the latch lever can be received in the holes 466 formed in the ears 464 on the latch link 550. With the latch lever 470 fully rotated toward the tablet computer 12, the cable 318 is trapped by the receptacle housing 472 and the tablet computer 12 in the cable receptacle 346.

The tablet computer lock mechanism 310 furthers include a rotating stand hub 580. The rotating stand hub 580 connects with the locking mechanism 316. The rotating stand hub 580 is movable with respect to the movable component 340, the fixed component 342 and the latch link 350. In the illustrated embodiment, the rotating stand hub 180 rotates about a rotational axis 582, which can be parallel to the rotational axis 420 of the lock 344. The rotating stand hub 580 includes an upper surface 584 (FIG. 5) and a lower surface 586 (FIG. 6).

The rotating stand hub 580 further includes a circular opening 588 that is centered with respect to the rotational axis 582. The circular opening 588 receives a cylindrical limit member 592, which limits the rotational movement of the rotating stand hub 580 with respect to the latch link 350. The limit member 592 includes a cylindrical section 594 having a quarter-circle bearing surface 596. An inwardly extending tab 598 rides within the quarter-circle bearing surface 594. The limit member 592 further includes a central opening 602 that receives the lock 344 to connect the limit member 592 and the rotating stand hub 580 with the movable component 340, the fixed component 342 and the latch link 350.

The rotating stand hub 580 further includes an axle attachments 614 having respective openings 616 for receiving an axle (not shown, but similar to axle 218) to connect an extendable leg 622 with the rotating stand hub 580.

The extendable leg 622 includes a first section 624 and a second section 626, which receives the first section. With reference to FIG. 6, the first section 624 includes a bearing 628 having an opening 632 that receives the axle for connecting the extendable leg 622 to the rotating stand hub 580. The extendable leg 622 can rotate about the axle (not shown, but similar to axle 218) with respect to the rotating stand hub 580. The first section 624 further includes a proximal notch 634 and a distal notch 636. The second section 626, which is hollow to receive the first section 624, includes an integral leaf spring 638 having a distal protrusion 642. The relief spring 638 is resilient. The distal protrusion 642 on the relief spring 638 is selectively receivable in each of the proximal notch 634 and the distal notch 636. To place the extendable leg 622 in the extended position, the distal protrusion 642 is received in the distal notch 636. To place the extendable leg 622 in the retracted position, the proximal notch 634 receives in the distal protrusion 642.

The rotating stand hub 580 is movable between a portrait position, which is shown in FIG. 1, and a landscape position, where the rotating stand hub 580 is rotated 90 degrees with respect to the position shown in FIG. 1. When in the portrait position, the extendable leg 622 is positioned with respect to the plurality of arms 314a, 314b to support the tablet computer 12 in a portrait orientation, such as that shown in FIG. 1. When in the landscape position, the extendable leg 622 is positioned with respect to the plurality of arms 314a, 314b to support the tablet computer in a landscape orientation. The extendable leg 622 can lock in the extended position and the retracted position. This allows the tablet computer 12 to be oriented in a portrait “up” orientation and a portrait “down” orientation. In the portrait “up” orientation the tablet computer 12 is nearer to vertical as compared to the portrait “down” orientation. Likewise, the tablet computer can be supported in a landscape “up” orientation and a landscape “down” orientation.

A tablet computer lock mechanism has been described above with particularity. Various presently unforeseen or unanticipated alternatives, modifications, variations or improvements therein may be subsequently made by those skilled in the art which are also intended to be encompassed by the following claims.

1. A tablet computer lock mechanism comprising:
at least two arms configured to grip an associated tablet computer, the at least two arms including at least one movable arm movable between an extended position and a retracted position; and
a locking mechanism operably connected with each arm and including a lock cable receptacle configured to receive an end of a lock cable, the locking mechanism operable in a locked mode and an unlocked mode,
when in the locked mode the locking mechanism is configured to preclude removal of the end of the lock cable from the lock cable receptacle and the at least one movable arm is in the retracted position, when the locking mechanism is in the locked mode each arm is positioned to grip the associated tablet computer whereby removal of the associated tablet computer from the at least two arms requires damage to the tablet computer lock mechanism and/or the associated tablet computer, and
when in the unlocked mode the locking mechanism is configured to allow removal of the end of the lock cable from the lock cable receptacle and the at least one movable arm is in the extended position whereby removal of the associated tablet computer from the at least two arms does not result in damage to the tablet computer lock mechanism and/or the associated tablet computer.

2. The mechanism of claim 1, wherein the locking mechanism includes:
a fixed component,
a movable component operably connected with the fixed component and the at least one movable arm, the movable component being movable with respect to the fixed component between a locked position and an unlocked position; and
a lock operably connected with at least one of the fixed component and the movable component, wherein the lock is operable between a locked state and an unlocked state, wherein the lock is movable from the unlocked state to the locked state when the movable component is in the locked position, wherein the lock precludes movement of the movable component with respect to the fixed component when in the locked state.

3. The mechanism of claim 2, wherein the movable component rotates with respect to the fixed component and rotational movement of the movable component with respect to the fixed component results in translational movement of the at least one movable arm with respect to the fixed component.

4. The mechanism of claim 2, wherein the movable component translates with respect to the fixed component and translational movement of the movable component with respect to the fixed component results in translational movement of the at least one movable arm with respect to the fixed component.

5. The mechanism of claim 2, wherein the lock includes a movable member, wherein the movable member engages the fixed component when the lock is in the locked state to preclude movement of the movable component with respect to the fixed component when the lock is in the locked state.

6. The mechanism of claim 2, wherein the fixed component includes an opening and the lock includes a movable member, wherein the movable member is offset from the opening when the movable component is in the unlocked position such that the lock is unable to occupy the locked state when the movable component is in the unlocked position.

7. The mechanism of claim 2, wherein the fixed component includes a cable receptacle housing defining the cable receptacle and the movable component includes a cable slot having a cable slot outlet, wherein the cable slot outlet aligns with the cable receptacle when the movable component is in the unlocked position.

8. The mechanism of claim 1, further comprising a rotating stand hub connected with the locking mechanism and a leg connected with the rotating stand hub.

9. The mechanism of claim 8, wherein the rotating stand hub is movable between a portrait position and a landscape position, when in the portrait position the leg is positioned with respect to the plurality of arms to support the associated tablet computer in a portrait orientation, when in the landscape position the leg is positioned with respect to the plurality of arms to support the associated tablet computer in a landscape orientation.

10. The mechanism of claim 8, wherein the leg connected with the rotating stand hub is an extendable leg, wherein the extendable leg locks into an extended position and a retracted position.

11. A tablet computer lock mechanism:
at least two arms configured to engage an associated tablet computer; and
a locking mechanism connected with each arm, the locking mechanism including a movable component, a fixed component operably connected with movable component, and a lock operably connected with at least one of the movable component and the fixed component,
wherein the at least two arms includes at least one movable arm operably connected with the movable component and movable between an extended position and a retracted position,
wherein the movable component is movable with respect to the fixed component between a locked position and an unlocked position;
wherein movement of the movable component with respect to the fixed component results in movement of the at least one movable arm with respect to the fixed component;
wherein the lock is operable between a locked state and an unlocked state, wherein the lock is movable from the unlocked state to the locked state when the movable component is in the locked position, wherein the lock precludes movement of the movable arm with respect to the fixed component when in the locked state.

12. The mechanism of claim 11, further comprising a cable receptacle in the locking mechanism, wherein an associated lock cable is removable from the cable receptacle when the movable component is in the unlocked position, wherein the associated lock cable is irremovable from the cable receptacle when the movable component is in the locked position.

13. The mechanism of claim 12, wherein the fixed component includes a cable receptacle housing defining the cable receptacle and the movable component includes a cable slot having a cable slot outlet, wherein the cable slot outlet aligns with the cable receptacle when the movable component is in the unlocked position.

14. The mechanism of claim 13, wherein the cable slot outlet is out of alignment with the cable receptacle when the movable component is in the locked position.

15. The mechanism of claim 11, further comprising a rotating stand hub connected with the locking mechanism and a leg connected with the rotating stand hub.

16. The mechanism of claim 15, wherein the rotating stand hub is connected with and movable with respect to the movable component and with respect to the fixed component.

17. The mechanism of claim 11, wherein the at least two arms includes at least two movable arms operably connected with the movable component and movable between the extended position and the retracted position, wherein movement of the movable component with respect to the fixed component results in translational movement of the at least two movable arms with respect to the fixed component.

18. A tablet computer lock mechanism:
at least two arms configured to engage an associated tablet computer;
a locking mechanism connected with each arm, the locking mechanism being configured to draw at least one of the at least two arms into engagement with an associated tablet computer; and
a cable lock mechanism associated with the locking mechanism, the cable lock mechanism being configured to capture a cable to preclude removal of the cable from the cable lock mechanism.

19. The mechanism of claim 18, wherein the locking mechanism includes a movable component movable between a locked position and an unlocked position, when the movable component is in the locked position the cable is precluded from removal from the cable lock mechanism, when the movable component is in the unlocked position the cable is removable from the cable lock mechanism.

20. The mechanism of claim 19, wherein movement of the movable component from the unlocked position toward the locked position results in movement of the at least one arm toward the associated tablet computer.
